(19) United States
(12) Patent Application Publication
(10) Pub. No.: US 2022/0089827 A1
(43) Pub. Date: Mar. 24, 2022

(54) THREE-DIMENSIONAL POROUS STRUCTURE AND FABRICATION METHOD THEREOF

(71) Applicant: OSANG M&ET CO., LTD., Busan (KR)

(72) Inventors: Sam Joo YOO, Busan (KR); Byoung Gil YOO, Busan (KR); Yu Jin LEE, Busan (KR)

(21) Appl. No.: 17/423,261

(22) PCT Filed: Mar. 12, 2019
(86) PCT No.: PCT/KR2019/002826

§ 371 Date: Jul. 15, 2021

(30) Foreign Application Priority Data
Jan. 18, 2019 (KR) 10-2019-0006780

(51) Int. Cl. C08J 9/24; C08J 9/00; C08J 9/232; C08J 9/36

(52) U.S. Cl. CPC C08J 9/24; C08J 9/0066; C08J 9/0061; C08J 2429/04; C08J 9/365; C08J 9/0004; C08J 2325/06; C08J 9/232

(57) ABSTRACT

Disclosed are a three-dimensional porous structure, a method of preparing the same, and applications thereof. The method includes coating a coating material including coal ash on a surface of a combustible organic particle to form a core-shell particle, wherein the core-shell particle includes a combustible organic particle core, and a coating shell covering at least a portion of the combustible organic particle surface; mixing a plurality of the core-shell particles with an organic or inorganic binder to form a three-dimensional structure in which the core-shell particles are bonded to each other; and performing thermal treatment of the three-dimensional structure, wherein in the thermal treatment of the three-dimensional structure, at least portion of the combustible organic particle in the core-shell particle is removed away, thereby forming a hollow inside the particle core, and forming a number of fine pores in the coating shell.

### FIELD

The present disclosure relates to a porous structure, and more specifically, to a three-dimensional porous structure, a method of preparing the same, and applications thereof.

### DESCRIPTION OF RELATED ART

About 8.5 million tons of coal ash are produced annually from coal-fired power plants, which occupy about 28% of a total domestic power plant capacity. Coal ash refers to a fine particle formed by rapidly cooling the remaining ash resulting from burning coal (bituminous coal and anthracite coal) as fuels of thermal power plants, at high temperatures, and is generally classified into fly ash and bottom ash. Although studies for recycling such coal ash are widely conducted, most of them are related to the treatment of the fly ash. However, the bottom ash is present in a mixed form of large particles of gravel sizes and fine powders. Thus, the sizes and distributions of the particles of the bottom ash are not uniform, leading to poor quality. For this reason, most of the bottom ash is buried in an ash pond. However, the burying capacity of the ach pond is limited. Further, due to the construction of coal-fired power plants and the combustion of low-calorie coals, the amount of the coal ash as produced is continuously increasing. Accordingly, there is a need for development of methods for treating the coal ash.

Sound-absorbing materials are building materials used for the purpose of absorbing sound, and are largely classified into porous sound-absorbing materials and plate-shaped sound-absorbing materials depending on the structure thereof. The porous sound-absorbing material has air bubbles or tube-shaped holes on the surface thereof and therein. Therein, sound energy is converted into heat energy due to friction produced when the air therein vibrates by sound waves. In such a porous sound-absorbing material, the sound-absorbing performance varies depending on the porosity and the thickness of the porous material. Thus, research and development of a new porous sound-absorbing material having better sound-absorbing performance is continuously required.

### DISCLOSURE

### Technical Purposes

One purpose of the present disclosure is to provide a preparation method of a three-dimensional porous structure with excellent porosity.

Another purpose of the present disclosure is to provide a three-dimensional porous structure with excellent porosity.

### Technical Solutions

A first aspect of the present disclosure provides a method for preparing a three-dimensional porous structure, the method comprising: coating a coating material including coal ash on a surface of a combustible organic particle to form a core-shell particle, wherein the core-shell particle includes a combustible organic particle core, and a coating shell covering at least a portion of the combustible organic particle surface; mixing a plurality of the core-shell particles with an organic or inorganic binder to form a three-dimensional structure in which the core-shell particles are bonded to each other; and performing thermal treatment of the three-dimensional structure, wherein in the thermal treatment of the three-dimensional structure, at least portion of the combustible organic particle in the core-shell particle is removed away, thereby forming a hollow inside the particle core, and forming a number of fine pores in the coating shell.

In one implementation of the first aspect, the combustible organic particle includes a combustible polymer particle.

In one implementation of the first aspect, the combustible polymer particle includes a Styrofoam particle.

In one implementation of the first aspect, the coal ash includes bottom ash.

In one implementation of the first aspect, the coating material further includes at least one of silica, cement, alumina, perlite or activated carbon.

In one implementation of the first aspect, the coating material includes silica and cement.

In one implementation of the first aspect, the coating material includes silica and cement, wherein as a content of silica in the coating material increases, a fine porosity of the coating shell achieved in the thermal treatment increases.

In one implementation of the first aspect, the coating material includes silica and cement, wherein as a content of cement in the coating material increases, a fine porosity of the coating shell achieved in the thermal treatment decreases.

In one implementation of the first aspect, the organic binder including polyvinyl alcohol, and the inorganic binder includes liquid potassium silicate.

In one implementation of the first aspect, the thermally treating of the three-dimensional structure is carried out at a temperature higher than a temperature at which the combustible organic particle is removed away.

In one implementation of the first aspect, the thermally treating of the three-dimensional structure is carried out in a temperature range of 200° C. to 300° C.

In one implementation of the first aspect, the thermally treating of the three-dimensional structure includes irradiating microwaves to the structure.

In one implementation of the first aspect, the thermally treating of the three-dimensional structure is carried out under an atmospheric atmosphere.

In one implementation of the first aspect, in forming the three-dimensional structure, at least portions of the shells of the core-shell particles are bonded to each other via the organic or inorganic binder such that a plurality of core-shell particles are irregularly connected to each other, and an empty space is formed between adjacent core-shell particles.

In one implementation of the first aspect, the combustible organic particle includes a Styrofoam particle, the coal ash includes bottom ash, and the binder includes liquid potassium silicate, wherein the thermally treating of the three-dimensional structure is carried out under an atmospheric atmosphere.

A second aspect of the present disclosure provides a three-dimensional porous structure prepared by the method as defined above, wherein the three-dimensional porous structure includes a number of hollow particles, each hollow particle having a hollow, and a shell covering the hollow and including a number of fine pores, wherein at least portions of the shells of the hollow particles are bonded to each other to form the three-dimensional porous structure.

In one implementation of the second aspect, the three-dimensional porous structure has: an inner hollow defined in each of the hollow particles; a plurality of fine pores defined in each shell of each hollow particle; and an empty space formed between adjacent hollow particles.

In one implementation of the second aspect, the porous structure is used as a sound absorbing material, a shock absorbing material, a filter material, a storage material, or an absorbent material.

### TECHNICAL EFFECTS

The present disclosure may provide a three-dimensional porous structure which may be produced via an easy process using the combustible organic particles and the coal ash coating material. The three-dimensional porous structure according to the present disclosure may have a structure in which the hollow particles, each having a hollow, and a shell covering the hollow and including a number of fine pores are connected to each other while at least portions of the shells thereof are bonded to each other. Thus, the structure may include a number of pores including an inner pore (first pore) as an inner empty space (hollow) of each of the hollow particles constituting the structure, a number of fine pores (second pores) formed in each of shells of the hollow particles, and empty spaces (third pores) formed between adjacent hollow particles. Thus, the three-dimensional porous structure according to the present disclosure has very excellent porosity. Further, the three-dimensional porous structure according to the present disclosure may include the shells with improved strength via the thermal treatment, and thus may exhibit excellent mechanical properties. In addition, according to the present disclosure, a three-dimensional porous structure according to the present disclosure may be formed in various forms such as blocks or panels according to a desired shape. Therefore, due to these characteristics, the three-dimensional porous structure according to the present disclosure may be applied to construction materials such as sound-blocking porous sound absorbing materials, insulation materials, and shock mitigating materials, or filtering materials, absorbent materials, and storage materials.

### BRIEF DESCRIPTION OF THE DRAWINGS

FIG. 1 is a diagram to describe the preparation method of the three-dimensional porous structure according to the present disclosure.

FIG. 2 is a diagram for illustrating a three-dimensional porous structure according to an implementation of the present disclosure.

FIG. 3A is a diagram for illustrating a three-dimensional porous structure according to an implementation of the present disclosure.

FIG. 3B is a diagram for illustrating a three-dimensional porous structure according to an implementation of the present disclosure.

FIG. 4 is a diagram for illustrating a three-dimensional porous structure according to another implementation of the present disclosure.

### DETAILED DESCRIPTIONS

Hereinafter, an embodiment of the present disclosure will be described in detail with reference to the accompanying drawings. The present disclosure may be variously modified and may take many forms. Thus, specific embodiments will be illustrated in the drawings and described in detail herein. However, the specific embodiments are not intended to limit the present disclosure thereto. It should be understood that all changes, equivalents thereto, or substitutes therewith are included in a scope and spirit of the present disclosure. In describing the drawing, similar reference numerals are used for similar components.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or greater other features, integers, operations, elements, components, and/or portions thereof.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

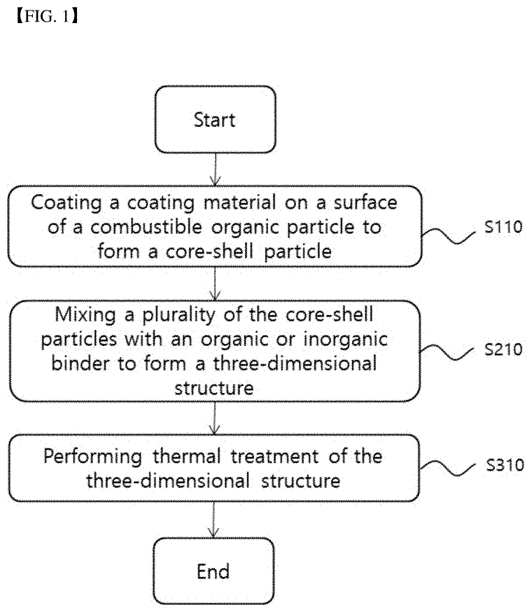

FIG. 1 is a diagram to illustrate the preparation method of the three-dimensional porous structure according to the present disclosure.

Referring to FIG. 1, the preparation method of the three-dimensional porous structure in accordance with the present disclosure includes coating a coating material including coal ash on a combustible organic particle surface to form a core-shell particle including the combustible organic particle core and a coating shell on the combustible organic particle surface (S10).

A combustible organic particle refers to an organic particle that is easily combustible. In accordance with the present disclosure, the combustible organic particle may mean a particle whose at least portion is lost or shrinkable by heat. In one example, the combustible organic particle may be a combustible polymer particle made of a polymer such as polystyrene. For example, when the combustible polymer particle is a polystyrene particle, the polystyrene particle may be a foamed polystyrene (Styrofoam) particle. In particular, the polystyrene particle may be waste Styrofoam particles obtained by pulverizing waste Styrofoam. When waste Styrofoam particles are used as combustible organic particles, cost may be saved due to material cost reduction and disposal cost reduction, which is economical and environmentally friendly in terms of waste resource recycling. Therefore, in accordance with the present disclosure, it may be desirable to use waste Styrofoam particles as the combustible organic particles.

A coated layer (coating shell) formed on the surface of the combustible organic particles may be formed using a coating material including the coal ash. In this connection, the formation method of the coating shell is not particularly limited as long as the method is capable of forming the coating shell on the combustible organic particle surface. A general coating method may be employed. In one example, the coating shell may be formed by mixing the coating material with an inorganic or organic binder, applying the mixture of the coating material and the binder on the surface of the combustible organic particles, and drying the mixture. In this connection, the binder may have the form of a solution including an inorganic material such as liquid potassium silicate or an organic material such as polyvinyl alcohol (PVA). In one example, in accordance with the present disclosure, the binder may be a mixture of organic and inorganic binders.

The coating shell may be formed to cover at least a portion of the combustible organic particle surface. For the mechanical properties of hollow particles and porous structures formed in subsequent processes of the present disclosure, it may be desirable to form the coating shell to completely cover the combustible organic particle surface.

The coating material includes the coal ash. The coal ash refers to a fine particle formed by cooling the ash remaining from burning coal bituminous coal and anthracite at high temperature, and may be interchangeable with incineration ash. In one example, the coal ash in accordance with the present disclosure may be coal ash produced from coal as fuel in a thermal power plant. The coal ash produced from coal as fuel in a thermal power plant may be classified into fly ash and bottom ash. However, in accordance with the present disclosure, it may be desirable that the coal ash be the bottom ash. The bottom ash is the residue in the furnace. The bottom ash contains non-combustible components and partially-combustible components that are only partially burned. According to the present disclosure, the coating material including the bottom ash as the coal ash may be coated on the combustible organic particle surface to form the coating shell thereon. The coating shell is thermally treated in a manner as described below in accordance with the present disclosure, such that combustible components of the coating shell made of the bottom ash may be burned to form fine pores in the coating shell, and the non-combustible components may be carbonized to improve the mechanical strength of the shell. Thus, a hollow particle having a shell having excellent mechanical properties and a porous structure including the same may be provided. Therefore, in accordance with the present disclosure, it may be desirable for the coating material to include the bottom ash.

Further, in one example, the coating material may further include at least one of silica, cement, alumina, perlite, and activated carbon. In this connection, the silica may mean sand rich in silicon dioxide (silica: SiO₂). In one example, when the coating material further includes silica and cement, it is possible to control the porosity of the porous structure according to the present disclosure which is formed via a subsequent process as described below, depending on the contents of silica and cement (the mixing ratio and the weight ratio thereof). The description thereof will be described in more detail below.

Next, the preparation method of the three-dimensional porous structure according to the present disclosure may include combining the core-shell particles to each other using an organic or inorganic binder to form a three-dimensional structure (S210), and preforming thermal treatment of the structure (S310).

In this connection, the three-dimensional structure may be formed by mixing the core-shell particles according to the present disclosure with an organic or inorganic binder, and drying the mixture in a mold. In accordance with the present disclosure, the formation of the three-dimensional structure may be performed within a mold frame of various shapes suitable for the intended use, shape, size, etc. of the structure. Thus, it is possible to provide a porous structure having various uses, shapes, and sizes. For example, the three-dimensional structure may be prepared in the form of panels, blocks, or tubes or rods. Further, the inorganic binder may be an inorganic binder such as liquid silicate, for example. The liquid silicate may include liquid potassium silicate. In one example, the organic binder may be an organic binder such as PVA.

The three-dimensional structure according to the present disclosure has a three-dimensional structure in which at least portions of the inorganic coated layer shells of the core-shell particles are bonded to each other via the binder, such that the core-shell particles are regularly or irregularly connected to each other. In this connection, the core-shell particles are spherical, so that empty spaces are formed between adjacent particles in the resulting structure.

When this three-dimensional structure is thermally treated, at least a portion of the combustible organic particles in the core-shell particles is lost or contracted, thereby forming a hollow inside the core-shell particle. Further, some of combustible components in the coating shell of the core-shell particle are burned via the thermal treatment, thereby forming a larger number of fine pores having a diameter in a micro-size range. Non-combustible components in the coating shell may be thermally treated to increase the strength of the shell in accordance with the present disclosure. That is, thermally treating the core-shell structured particle including the combustible organic particle core and the coating shell covering the core may allow forming hollow particles having the hollow and the shell covering the hollow and including fine pores. Therefore, the three-dimensional porous structure according to the present disclosure which has a structure in which a number of the hollow particles are connected to each other by bonding at least portions of shells thereof to each other may include a number of pores including an inner pore (first pore) as an inner empty space (hollow) of each of the hollow particles constituting the structure, a number of fine pores (second pores) formed in each of shells of the hollow particles, and empty spaces (third pores) formed between adjacent hollow particles. Thus, the three-dimensional porous structure according to the present disclosure has very excellent porosity.

Further, the joint between adjacent shells in the structure may be strengthened via thermal treatment. Accordingly, the three-dimensional porous structure also has excellent mechanical properties via the solid bonding between the shells of the hollow particles as well as the improved mechanical properties of the shell itself.

The thermal treatment may be performed by heating the three-dimensional structure. Alternatively, the thermal treatment may be carried out by irradiating microwaves thereto. In this connection, the complete loss of the combustible organic particles may improve the inner porosity of the porous structure. Thus, it may be desirable to perform the thermal treatment at a temperature above the temperature at which the combustible organic particles may be lost. In one example, when the combustible organic particles are embodied as waste Styrofoam particles, the step of thermally treating the structure may be performed in a temperature range of 200° C. to 300° C. Further, the thermal treatment may be preferably performed under an atmospheric atmosphere.

In one example, when the coating material of the core-shell particle according to the present disclosure further includes silica and cement, the porosity of fine pores in the thermally treated coating shell may be controlled according to the mixing amount (weight ratio) of silica and cement in the coating material. Specifically, as the content of the cement increases, the number, size, diameter, and distribution of fine pores formed in the thermally treated coating shell decrease, resulting in a decrease in fine porosity in the shell. Accordingly, the shell may have relatively smooth inner and outer wall surfaces. On the other hand, as the weight ratio of the silica increases, the larger number of fine pores may be formed in the thermally treated shell. Thus, the fine porosity of the shell may be improved. Accordingly, it is possible to provide a three-dimensional porous structure in which the fine porosity is controlled according to the intended use thereof according to the present disclosure, based on these characteristics. In one example, the hollow size of the three-dimensional porous structure may be controlled according to the size of the combustible organic particles as used and may have a diameter of 1 to 20 mm.

The three-dimensional porous structure according to the present disclosure which is prepared according to the preparation method of the present disclosure may have a structure in which the hollow particles, each having a hollow, and a shell covering the hollow and including a number of fine pores are connected to each other while at least portions of the shells thereof are bonded to each other. Thus, the structure may include a number of pores including an inner pore (first pore) as an inner empty space (hollow) of each of the hollow particles constituting the structure, a number of fine pores (second pores) formed in each of shells of the hollow particles, and empty spaces (third pores) formed between adjacent hollow particles. Thus, the three-dimensional porous structure according to the present disclosure has very excellent porosity. Further, the three-dimensional porous structure according to the present disclosure may include the shells with improved strength via the thermal treatment, and thus may exhibit excellent mechanical properties.

Therefore, the three-dimensional porous structure according to the present disclosure in which hollow particles mainly composed of the products resulting from the thermal treatment of the coal ash, especially, the bottom ash are connected to each other has excellent mechanical properties and remarkably high porosity. Thus, in one example, the three-dimensional porous structure according to the present disclosure may exhibit very good sound absorption performance Accordingly, the three-dimensional porous structure according to the present disclosure may be used for a porous sound-absorbing material that has high porosity and physical properties and exhibits excellent sound-absorbing performance. In addition, the three-dimensional porous structure according to the present disclosure may exhibit excellent performance when used as an insulating material or shock mitigating material requiring excellent porosity. Therefore, the three-dimensional porous structure according to the present disclosure may be used as a functional building material such as sound absorbing material, shock mitigating material, and insulation material. In this connection, the building material may be used for flooring, ceiling, interior, exterior, wall, and aggregate. In addition, the three-dimensional porous structure according to the present disclosure may act as a porous support and thus may be used as a filter material such as a filter, an absorbent material, or a storage material.

Hereinafter, a method of preparing a three-dimensional porous structure according to the present disclosure and a three-dimensional porous structure as prepared accordingly will be described in more detail with reference to specific Examples.

First, the coated layer made of the coating material was coated on the Styrofoam particle surface by mixing Styrofoam particles, the coating material as mixture powders of bottom ashes and mortar cement as a mixture of silica and cement, and liquid potassium silicate as an inorganic binder with each other. Thus, the core-shell particles were prepared.

Subsequently, the core-shell particles were mixed with liquid potassium silicate again, and then the mixture was injected into a mold, and was dried to prepare the three-dimensional structure.

Then, the structure was thermally treated at a temperature of 250° C. in the air to prepare a three-dimensional porous structure according to Example 1 of the present disclosure.

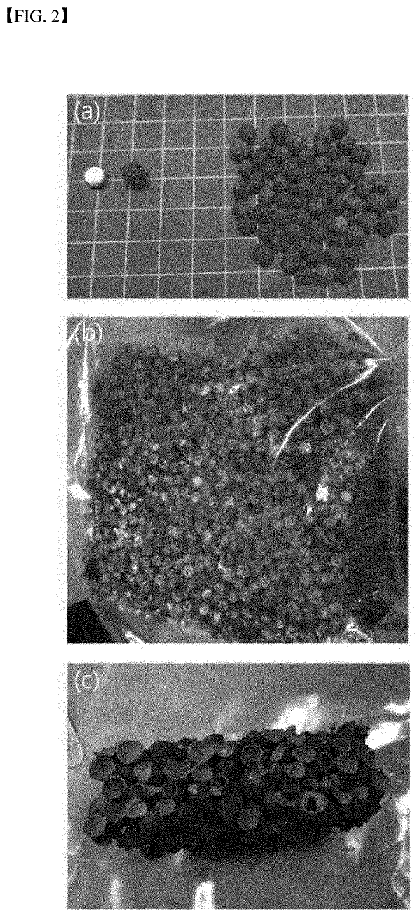

FIG. 2 is a diagram for illustrating a three-dimensional porous structure according to an example of the present disclosure.

(a) in FIG. 2 is a photograph of a core-shell particle having a Styrofoam particle core and a bottom ash/silica/cement shell according to the present disclosure. (b) in FIG. 2 is a photograph of a three-dimensional porous structure according to Example 1 of the present disclosure. (c) in.

FIG. 2 is a photograph of a cut section of a three-dimensional porous structure according to Example 1 of the present disclosure.

Referring to FIG. 2, it may be identified that the three-dimensional porous structure according to the present disclosure which is prepared according to the preparation method of the present disclosure may have a structure in which the hollow particles, each having a hollow, and a shell covering the hollow and including a number of fine pores are connected to each other while at least portions of the shells thereof are bonded to each other.

Specifically, as shown in (c) in FIG. 2, it may be identified that when the core-shell particle ((a) in FIG. 2) having the Styrofoam particle core and the coating shell as a mixture of bottom ash/silica/cement formed on the Styrofoam particle core surface is thermally treated, the Styrofoam in the particle is lost and thus an empty space (hollow) is formed. Further, it may be identified that the shape of the particle does not collapse due to the loss of the Styrofoam in the particle, and rather, the hollow particle composed of the hollow space and the coating shell covering the hollow space is formed. In other words, it may be identified that the coating shell of the core-shell particle according to the present disclosure is not lost due to the thermal treatment and remains as the shell even after the thermal treatment, thus maintaining the particle shape, and the Styrofoam of the core-shell particle is lost via the thermal treatment to forms an empty space (hollow). In addition, it may be identified that while the hollow particles share at least portions of shells thereof with each other, the particles are bonded to each other to form a solid three-dimensional structure.

Accordingly, it may be identified that the three-dimensional porous structure according to the present disclosure has excellent porosity due to the hollow inside the hollow particle and empty spaces formed between the adjacent particles.

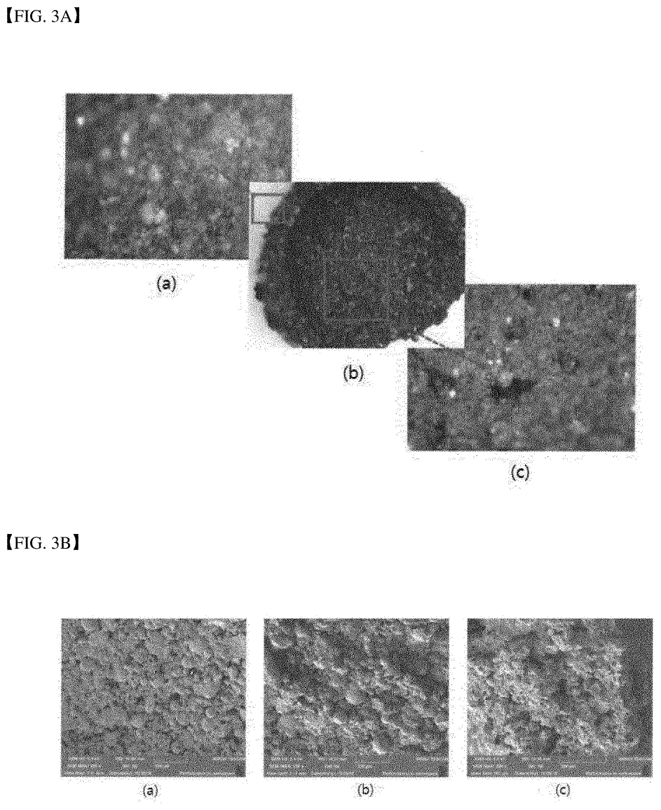

Further, in order to identify the fine pore structure in the shell of the three-dimensional porous structure according to the present disclosure, an outer wall, a cross section, and an inner wall of one of the hollow particles constituting the three-dimensional porous structure according to Example 1 were photographed. The results are shown in FIG. 3A.

FIG. 3A is a diagram for illustrating a three-dimensional porous structure according to an Example 1 of the present disclosure.

In FIG. 3A, (a) shows the outer wall of the hollow particle in the three-dimensional porous structure according to Example 1 of the present disclosure, (b) shows the cross section of the hollow particle, and (c) shows the inner wall of the hollow particle.

Referring to FIG. 3A, it may be identified that pores are formed in the shell of the hollow particle formed according to the present disclosure.

To describe this structure in more detail, SEM images of the inner wall, outer wall and cross section of the hollow particle shell were taken. The results are shown in FIG. 3B.

FIG. 3B is a diagram for illustrating a three-dimensional porous structure according to an example of the present disclosure.

In FIG. 3B, (a) is the SEM image of the inner wall of the shell of the hollow particle in the three-dimensional porous structure according to Example 1 of the present disclosure. (b) is the SEM image of the shell outer wall of the hollow particle. (c) is the SEM image of the shell cross section of the hollow particle.

Referring to FIG. 3B, it may be identified that a number of fine pores are formed in the shell of the hollow particle in the three-dimensional porous structure according to Example 1 of the present disclosure.

Further, the three-dimensional porous structure according to Example 2 of the present disclosure was prepared by performing substantially the same process as the preparation method of the three-dimensional porous structure according to Example 1 except that mixture powders of bottom ash and cement were used as the coating material when the core-shell particles were prepared according to the present disclosure.

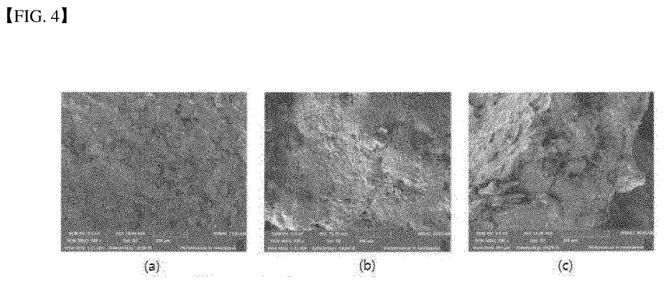

FIG. 4 shows SEM images of the inner wall, the outer wall and the cross-section of the hollow particle in the three-dimensional porous structure.

FIG. 4 is a diagram for illustrating a three-dimensional porous structure according to another example of the present disclosure.

In FIG. 4, (a) is a SEM image of the inner wall of the shell of the hollow particle in the three-dimensional porous structure according to Example 2 of the present disclosure. (b) is the SEM image of the outer wall of the shell of the hollow particle. (c) is the SEM image of the cross section of the shell of the hollow particle.

Referring to FIG. 4 together with the FIGS. 2 and 3A and 3B, it may be identified that the size of each of the fine pores in the shell formed using only the bottom ash and the cement as a coating material according to Example 2 of the present disclosure is smaller than the size of each of the fine pores in the shell formed using the bottom ash, the cement and the silica as a coating material according to Example 1 of the present disclosure. Further, it may be identified that the inner and outer wall surfaces of the shell formed using only the bottom ash and the cement as a coating material according to Example 2 of the present disclosure are relatively smooth. This indicates that the number, distribution and size of the fine pores may be increased when the silica is contained in the coating material. Thus, the porosity of fine pores in the shell may be controlled by controlling the content of each of silica and cement in the coating material according to the present disclosure.

That is, as identified above, the core-shell particles may be formed using the combustible organic particles and the coating material according to the present disclosure. The thermal treatment of the particles may allow the formation of the hollow particles, each having the hollow and the shell covering the hollow. Further, it may be identified that the hollow particles may be bonded to each other to prepare the three-dimensional porous structure. Further, it may be identified that the three-dimensional porous structure according to the present disclosure has particularly good porosity due to the hollow defined in each of the hollow particles and the fine pores in the shell and the empty space formed between the adjacent particles bonded to each other.

In addition, the three-dimensional porous structure according to the present disclosure may have not only improved mechanical strength of the shell via the thermal treatment of the coating material, but also excellent mechanical properties because the adjacent hollow particles are bonded to each other while the adjacent hollow particles share portions of the shells thereof with each other. In particular, the three-dimensional porous structure according to the present disclosure may be prepared in various forms, and thus the porous structure according to the present disclosure may be used as a material of various types requiring high porosity.

Although the embodiments of the present disclosure have been described in more detail with reference to the accompanying drawings, the present disclosure is not necessarily limited to these embodiments. The present disclosure may be implemented in various modified manners within the scope not departing from the technical idea of the present disclosure. Accordingly, the embodiments disclosed in the present disclosure are not intended to limit the technical idea of the present disclosure, but to describe the present disclosure. the scope of the technical idea of the present disclosure is not limited by the embodiments. Therefore, it should be understood that the embodiments as described above are illustrative and non-limiting in all respects. The scope of protection of the present disclosure should be interpreted by the claims, and all technical ideas within the scope of the present disclosure should be interpreted as being included in the scope of the present disclosure.

1. A method for preparing a three-dimensional porous structure, the method comprising:
coating a coating material including coal ash on a surface of a combustible organic particle to form a core-shell particle, wherein the core-shell particle includes a combustible organic particle core, and a coating shell covering at least a portion of the combustible organic particle surface;
mixing a plurality of the core-shell particles with an organic or inorganic binder to form a three-dimensional structure in which the core-shell particles are bonded to each other; and
performing thermal treatment of the three-dimensional structure,
wherein in the thermal treatment of the three-dimensional structure, at least portion of the combustible organic particle in the core-shell particle is removed away, thereby forming a hollow inside the particle core, and forming a number of fine pores in the coating shell.

2. The method of claim 1, wherein the combustible organic particle includes a combustible polymer particle.

3. The method of claim 2, wherein the combustible polymer particle includes a Styrofoam particle.

4. The method of claim 1, wherein the coal ash includes bottom ash.

5. The method of claim 1, wherein the coating material further includes at least one of silica, cement, alumina, perlite or activated carbon.

6. The method of claim 5, wherein the coating material includes silica and cement.

7. The method of claim 6, wherein the coating material includes silica and cement, wherein as a content of silica in the coating material increases, a fine porosity of the coating shell achieved in the thermal treatment increases.

8. The method of claim 6, wherein the coating material includes silica and cement, wherein as a content of cement in the coating material increases, a fine porosity of the coating shell achieved in the thermal treatment decreases.

9. The method of claim 1, wherein the organic binder including polyvinyl alcohol, and the inorganic binder includes liquid potassium silicate.

10. The method of claim 1, wherein the thermally treating of the three-dimensional structure is carried out at a temperature higher than a temperature at which the combustible organic particle is removed away.

11. The method of claim 1, wherein the thermally treating of the three-dimensional structure is carried out in a temperature range of 200° C. to 300° C.

12. The method of claim 1, wherein the thermally treating of the three-dimensional structure includes irradiating microwaves to the structure.

13. The method of claim 1, wherein the thermally treating of the three-dimensional structure is carried out under an atmospheric atmosphere.

14. The method of claim 1, wherein in forming the three-dimensional structure, at least portions of the shells of the core-shell particles are bonded to each other via the organic or inorganic binder such that a plurality of core-shell particles are irregularly connected to each other, and an empty space is formed between adjacent core-shell particles.

15. The method of claim 1, wherein the combustible organic particle includes a Styrofoam particle, the coal ash includes bottom ash, and the binder includes liquid potassium silicate,
wherein the thermally treating of the three-dimensional structure is carried out under an atmospheric atmosphere.

16. A three-dimensional porous structure prepared by the method according to claim 1,
wherein the three-dimensional porous structure includes a number of hollow particles, each hollow particle having a hollow, and a shell covering the hollow and including a number of fine pores,
wherein at least portions of the shells of the hollow particles are bonded to each other to form the three-dimensional porous structure.

17. The three-dimensional porous structure of claim 16, wherein the three-dimensional porous structure has:
an inner hollow defined in each of the hollow particles;
a plurality of fine pores defined in each shell of each hollow particle; and
an empty space formed between adjacent hollow particles.

18. The three-dimensional porous structure of claim 16, wherein the porous structure is used as a sound absorbing material, a shock absorbing material, a filter material, a storage material, or an absorbent material.
